(19) United States
(12) Patent Application Publication
(10) Pub. No.: US 2021/0086313 A1
(43) Pub. Date: Mar. 25, 2021

(54) SOLID WIRE FOR GAS-SHIELDED ARC WELDING OF THIN STEEL SHEET

(71) Applicant: NIPPON STEEL CORPORATION, Tokyo (JP)

(72) Inventors: Shinji KODAMA, Tokyo (JP); Masahiro MATSUBA, Tokyo (JP); Masafumi AZUMA, Tokyo (JP); Yoichiro MORI, Tokyo (JP); Kenichiro OTSUKA, Tokyo (JP); Tetsuro NOSE, Tokyo (JP); Tomokatsu IWAKAMI, Tokyo (JP); Kazutaka MARUYAMA, Tokyo (JP)

(73) Assignee: NIPPON STEEL CORPORATION, Tokyo (JP)

(21) Appl. No.: 16/759,784

(22) PCT Filed: Dec. 17, 2018
(86) PCT No.: PCT/JP2018/046327

§ 371 Date: Apr. 28, 2020

(30) Foreign Application Priority Data
Dec. 19, 2017 (JP) 2017-243276

(51) Int. Cl. B23K 35/30; C22C 38/54; C22C 38/50; C22C 38/48; C22C 38/46; C22C 38/44; C22C 38/42; C22C 38/06; C22C 38/04; C22C 38/02; C22C 38/00; B23K 35/02; B23K 9/00

(52) U.S. Cl. CPC B23K 35/3073; B23K 2103/04; C22C 38/50; C22C 38/48; C22C 38/46; C22C 38/44; C22C 38/42; C22C 38/06; C22C 38/04; C22C 38/02; C22C 38/002; B23K 35/0261; B23K 9/0035; B23K 35/3093; C22C 38/54

(57) ABSTRACT

This wire for gas-shielded arc welding is a wire for joining a plurality of thin steel sheets by gas-shielded arc welding, the wire including, in mass %, with respect to a total mass of the wire: C: 0.06 to 0.15%; Si: more than 0 to 0.18%; Mn: 0.3 to 2.2%; Ti: 0.06 to 0.30%; Al: 0.001 to 0.30%; and B: 0.0030 to 0.0100%, in which Si, Mn, Ti, and Al satisfy Expressions (1) and (2).

Si×Mn≤0.30 Expression (1)

(Si+Mn/5)/(Ti+Al)≤3.0 Expression (2)

### TECHNICAL FIELD OF THE INVENTION

The present invention relates to a solid wire for gas-shielded arc welding to a thin steel sheet.

The present application claims the priority based on Japanese Patent Application No. 2017-243276, filed on Dec. 19, 2017, the content of which is incorporated herein by reference.

### RELATED ART

Gas-shielded arc welding is widely used in various fields. For example, in the automobile field, gas-shielded arc welding is used for welding suspension members and the like.

When gas-shielded arc welding using a solid wire is performed on a steel member, oxygen contained in the oxidizing gas in the shielding gas reacts with an element such as Si and Mn included in a steel material and a wire, thereby generating a Si- or Mn-based slag including a Si oxide or a Mn oxide as a main structure. As a result, a large amount of Si- or Mn-based slag remains on a surface of a weld bead which is a melting solidification portion.

Members requiring corrosion resistance, such as suspension members for automobiles, are subjected to electrodeposition coating after welding assembling. When this electrodeposition coating is performed, if a Si- or Mn-based slag remains on a surface of a weld bead, electrodeposition coating properties of that portion are deteriorated. As a result, corrosion resistance in locations of the Si- or Mn-based slag remaining is degraded. Here, the electrodeposition coating properties refer to characteristics evaluated by the area of a portion that is not coated after an electrodeposition coating treatment (electrodeposition coating defective portion).

The reason why the electrodeposition coating properties are degraded in a location in which a Si- or Mn-based slag remains is that a Si oxide or a Mn oxide, which is an insulation material, blocks energization at the time of electrodeposition coating, and coating does not adhere to the entire surface.

The Si- or Mn-based slag is a by-product of a deoxidation process for a weld and Si or Mn included in a solid wire has an effect of securing the strength of the welded metal and stabilizing the weld bead shape. Thus, in gas-shielded arc welding using a solid wire, it is difficult to prevent the Si- or Mn-based slag from being generated. As a result, corrosion of a weld is unavoidable even in a member subjected to electrodeposition coating.

Accordingly, in design of suspension members and the like for automobiles, the sheet thickness thereof is designed to be thicker in consideration of thickness reduction caused due to corrosion, which has become an obstacle to thinning realized by using a high tensile strength steel material.

With regard to such a problem, in Patent Document 1, a countermeasure to improve electrodeposition coating properties by suppressing the Al content in a solid wire and reducing the area ratio of slag on a weld bead is proposed. In addition, in Patent Document 2, a solid wire for pulse MAG welding in which the Si content is controlled to be less than 0.10% is proposed. Patent Document 2 describes that a flat and wide bead shape with less amount of spatters generated in welding of thin steel sheets and good compatibility with welded members can be obtained by using such a solid wire.

### PRIOR ART DOCUMENT

### Patent Document

[Patent Document 1] Japanese Patent No. 5652574

[Patent Document 2] Japanese Patent No. 5037369

### DISCLOSURE OF THE INVENTION

### Problems to be Solved by the Invention

However, in the technique of Patent Document 1, for example, in a case where a steel member having a high Si content or Mn content is welded, a Si- or Mn-based slag is generated in a streak shape particularly along the toe portion of the weld bead and this technique is not sufficient as a countermeasure for poor electrodeposition coating.

In addition, in a case where the composition design of a steel member and a solid wire is performed such that the Si content or Mn content in the weld are reduced, although a problem of poor electrodeposition coating is solved, the tensile strength of the weld cannot be secured, and internal defects due to a blowhole caused by insufficient deoxidation may occur.

In addition, when the wire described in Patent Document 2 is used, an effect of reducing the amount of slag due to a reduction in the amount of Si in the wire is obtained. However, even when the wire is used, the use of this wire is not sufficient as a countermeasure for poor electrodeposition coating for a steel member having a high Si content or Mn content as in Patent Document 1. In the first place, in Patent Document 2, the effect of the weld with respect to coating properties is not verified, and the effect of wire components other than Si is unknown.

Further, in the manufacturing line of automobiles, welding is performed by robots with an emphasis on productivity, and in order to save the time required for wire replacement, it is also required that one type of solid wire is applicable to both welding of low strength steel sheets and welding of high strength steel sheets.

The present invention has been made in view of the above circumstances, and an object thereof is to provide a solid wire for gas-shielded arc welding capable of forming a weld having excellent electrodeposition coating properties and mechanical properties, and applicable to both welding of low strength steel sheets and welding of high strength steel sheets.

### Means for Solving the Problem

The specific method of the present invention is as follows.

(1) According to a first aspect of the present invention, there is provided a solid wire for gas-shielded arc welding for joining a plurality of thin steel sheets by gas-shielded arc welding, the wire including, in mass %, with respect to a total mass of the wire: C: 0.06 to 0.15%; Si: more than 0 to 0.18%; Mn: 0.3 to 2.2%; Ti: 0.06 to 0.30%; Al: 0.001 to 0.30%; B: 0.0030 to 0.0100%; P: more than 0 to 0.015%; S: more than 0 to 0.030%; Sb: 0 to 0.10%; Cu: 0 to 0.50%; Cr: 0 to 1.5%; Nb: 0 to 0.3%; V: 0 to 0.3%; Mo: 0 to 1.0%; Ni: 0 to 3.0%; and a remainder consisting of iron and impurities, in which Si, Mn, Ti, and Al satisfy Expressions (1) and (2),

Si×Mn≤0.30 Expression (1)

(Si+Mn/5)/(Ti+Al)≤3.0 Expression (2)

where element symbols in Expressions (1) and (2) represent contents (mass %) of individual elements.

(2) In the solid wire for gas-shielded arc welding according to (1), an Al content may be 0.01 to 0.14%.

(3) In the solid wire for gas-shielded arc welding according to (1) or (2), Si, Mn, Ti, Al, S, and Sb may satisfy Expressions (3) and (4),

0.012≤4×S+Sb≤0.120 Expression (3)

(Si+Mn/5)/((Ti+Al)×(4×S+Sb))≤220 Expression (4)

where element symbols in Expressions (3) and (4) represent contents (mass %) of individual elements.

(4) In the solid wire for gas-shielded arc welding according to (1) or (2), a Nb content may be 0.005% or less.

(5) In the solid wire for gas-shielded arc welding according to (1) or (2), a B content may be 0.0032% or more.

(6) In the solid wire for gas-shielded arc welding according to (1) or (2), a Mn content may be 0.3 to 1.7%.

(7) In the solid wire for gas-shielded arc welding according to (1) or (2), B and Ti may satisfy Expression (5),

B≥(−54Ti+43)/10000 Expression (5)

where element symbols in Expression (5) represent contents (mass %) of individual elements.

### Effects of the Invention

According to the solid wire for gas-shielded arc welding of the present invention, it is possible to form a weld having excellent electrodeposition coating properties and mechanical properties (such as tensile strength and elongation) by appropriately controlling the component composition. Particularly, it is possible to apply a solid wire having the same chemical composition to both welding of low strength steel sheets and welding of high strength steel sheets by appropriately controlling the B content.

### BRIEF DESCRIPTION OF THE DRAWINGS

FIG. 1 is a graph showing the relationship between the Ti content (mass %) of a welding wire and the amount of oxygen (mass ppm) of a deposited metal.

FIG. 2 is a graph showing the relationship between the Ti content (mass %) of the welding wire and the B content (mass ppm) of a welded metal.

### EMBODIMENTS OF THE INVENTION

The present inventors have conducted intensive investigations on the countermeasures for solving the above problems and have obtained the following findings.

(A) By reducing the amount of Si of a solid wire as much as possible and suppressing the generation of a Si-based slag, the electrodeposition coating properties can be improved. In the chemical composition with a small amount of Si, the degree of deterioration of the electrodeposition coating properties by a Mn slag is small.

(B) By controlling the Ti content of the solid wire within an appropriate range, a conductive Ti-based slag is generated on the surface of a weld bead, and thus the electrodeposition coating properties are improved.

(C) By adding B to the solid wire, in a case of performing welding on a thin steel sheet formed of 980 MPa class high tensile steel, the strength improvement by B is remarkable for a welded metal including bainite and martensite as main structures. Accordingly, the strength of the welded metal can be secured and the solid wire having the same chemical composition can be applied to welding of 440 MPa class mild steel to 980 MPa class high tensile steel.

(D) By controlling the Ti content and the Al content of the solid wire within appropriate ranges, the generation of an insulating Si- or Mn-based slag is suppressed, and thus the electrodeposition coating properties are improved.

(E) In addition to these controls, by controlling the S content and the Sb content of the solid wire within appropriate ranges, inward convection occurs in a weld pool due to an increase in the surface tension of a molten pool and the Si- or Mn-based slag is prevented from remaining at the toe portion of the weld bead. Thus, the electrodeposition coating properties are further improved.

Based on the above findings, the present inventors have found an appropriate component composition for a solid wire for gas-shielded arc welding. The solid wire for gas-shielded arc welding of the present invention achieves the intended effects of the present invention due to the synergistic effect of each component composition alone and the coexistence thereof, but the reasons for limiting the composition of each component will be described below.

The solid wire is a steel wire having a predetermined component, or a wire obtained by coating the surface of a steel wire with copper. The total wire mass means the total mass of the solid wire including coating. In addition, in the following description, the chemical composition of the solid wire is expressed by mass %, which is a proportion with respect to the total mass of the wire, and the description relating to the mass % is simply described as %.

In this specification, the term “welded metal” means a component in which a steel sheet base metal and a welding wire are melted and mixed, and the term “deposited metal” means a metal prepared by performing multi-layer welding and using only the welding wire component.

In addition, the term “thin steel sheet” means a steel sheet having a sheet thickness of 1.2 mm to 3.6 mm and the term “thick steel plate” means a steel plate having a plate thickness of about 6 mm to 30 mm.

[C: 0.06 to 0.15%]

Since C has an effect of stabilizing an arc and reducing the particle size of a droplet, when the C content is less than 0.06%, a droplet becomes too coarse, an arc becomes unstable, and the amount of spatter generated tends to increase. In addition when the C content is less than 0.06%, tensile strength may not be obtained in a deposited metal. Thus, the C content is 0.06% or more and preferably 0.07% or more.

On the other hand, when the C content is more than 0.15%, the viscosity of a molten pool decreases to deteriorate the bead shape. In addition, the deposited metal is hardened and the cracking resistance is lowered. Thus, the C content is 0.15% or less and preferably 0.12% or less.

[Si: More than 0 to 0.18%]

As a deoxidizing element in a normal welding wire, Si is actively added. In addition, by promoting deoxidation of a molten pool during arc welding with Si, the tensile strength of the deposited metal is improved. However, from the viewpoint of electrodeposition coating properties, it is desirable to reduce an insulating Si oxide as much as possible. Therefore, the Si content is 0.18% or less, preferably 0.13% or less, more preferably 0.10% or less, and even more preferably 0.08% or less. On the other hand when the Si content is more than 0%, good electrodeposition coating properties can be obtained. However, from the viewpoint of securing the manufacturing cost of the wire and the stability of the bead shape, the Si content is preferably 0.001% or more.

[Mn: 0.3 to 2.2%]

Mn is a deoxidizing element like Si and is an element that promotes deoxidation of the molten pool during arc welding and improves the tensile strength of the deposited metal. Thus, the Mn content is 0.3% or more and preferably 0.5% or more.

On the other hand, when Mn is excessively contained, an insulating Mn-based slag is significantly generated on the surface of a weld bead and thus poor electrodeposition coating tends to occur. However, in the chemical composition having a small amount of Si-based slag, the degree of deterioration of coating properties due to a Mn-based slag is not large. Thus, the Mn content is 2.2% or less, preferably 1.7%, and more preferably 1.5% or less.

As described above, Si and Mn are elements that have an adverse effect on electrodeposition coating properties, but in the chemical composition with a small amount of Si, the degree of deterioration of coating properties due to a Mn-based slag is small.

Here, in a solid wire according an embodiment, Si and Mn contents are set so as to satisfy Expression (1).

Si×Mn≤0.30 Expression (1)

In a case where the value of Si×Mn is more than 0.30, insulating Si-based slag and Si-Mn-based slag are significantly generated on the surface of the weld bead, and thus there is a risk of poor electrodeposition coating. Thus, the value of Si×Mn is 0.30 or less and preferably 0.20 or less.

[Ti: 0.06 to 0.30%]

When gas-shielded arc welding is performed on a steel member using a solid wire, oxygen contained in the oxidizing gas in the shielding gas reacts with an element such as Si or Mn included in a steel material or wire to generate a Si- or Mn-based slag including a Si oxide or a Mn oxide as a main structure. As a result, a large amount of Si- or Mn-based slag remains on a surface of a weld bead which is a melting solidification portion.

Ti reacts with oxygen in the shielding gas using when gas-shielded arc welding is performed to generate a Ti-based slag including a Ti oxide as a main structure. Since the Ti-based slag is conductive unlike the Si- or Mn-based slag, even when the Ti-based slag is generated on the surface of the weld bead, poor electrodeposition coating is less likely to occur. Accordingly, when Ti is actively contained in the solid wire and oxygen in the shielding gas reacts with Ti, the amount of Si- or Mn-based slag generated can be reduced, and thereby the electrodeposition coating properties can be improved. Therefore, the Ti content is 0.06% or more and preferably 0.10% or more.

From the viewpoint of improvement of coating properties, when the Si or Mn content of the solid wire is reduced, the deoxidizing effect of a melted metal during arc welding is not sufficient and thus a blowhole is generated due to the generation of CO gas. Ti also has an effect of suppressing blowholes due to the generation of CO gas as a deoxidizing element.

On the other hand, when Ti is excessively contained, Ti-based oxides are excessively formed, and the elongation of the deposited metal is lowered. Thus, the Ti content is 0.30% or less and preferably 0.25%.

[Al: 0.001 to 0.30%]

Al is a deoxidizing element and promotes deoxidation of a melted metal during arc welding to improve the tensile strength of the deposited metal. Thus, the Al content is 0.001% or more.

In addition, as described above, Al generates an insulating Al-based slag, but in a case where the Al content is 0.01% or more, like Ti, the amount of Si- or Mn-based slag generated can be reduced, thereby improving the electrodeposition coating properties. Thus, in order to more reliably prevent the poor electrodeposition coating, the Al content is preferably 0.01% or more.

On the other hand, when Al is excessively contained, Al-based oxides are excessively formed and the elongation of the deposited metal is lowered. In addition, since the Al-based slag has insulation properties like a Si-based slag and a Mn-based slag, when the Al-based slag is significantly generated on the surface of the weld bead, there is a risk of the poor electrodeposition coating. Thus, the Al content is 0.30% or less and preferably 0.14% or less.

As described above, Ti and Al are elements that can suppress adverse effects on electrodeposition coating properties due to a Si- or Mn-based slag.

Therefore, in the present invention, the contents of Si, Mn, Ti, and Al are set so as to satisfy Expression (2).

(Si+Mn/5)/(Ti+Al)≤3.0 Expression (2)

In a case where the value of (Si+Mn/5)/(Ti+Al) is 3.0 or less, adverse effects on electrodeposition coating properties due to a Si- or Mn-based slag can be reliably suppressed and excellent electrodeposition coating properties can be obtained. The value of (Si+Mn/5)/(Ti+Al) is preferably 2.0 or less.

In Expression (1), the product of Si and Mn is used as an index, but in Expression (2), the sum of Si and Mn/5 is used as an index. This is because Ti and Al are added to reduce the absolute amount of Si- or Mn-based slag.

[B: 0.0030 to 0.0100%]

Since the Si and Mn contents are limited in the welding wire according to embodiment from the viewpoint of electrodeposition coating properties of the weld, it is difficult to obtain the strength improvement effect with Si and Mn expressed by carbon equivalent (Ceq=C+Si/24+Mn/6+Ni/40+Cr/5+Mo/4+V/14). Therefore, the strength of the welded metal is secured by adding a small amount of B which does not adversely affect the coating properties.

Generally, in the welding of thick steel plates, the weld is subjected to groove machining and the inside of the groove is filled with multilayer welding to prepare a welded joint. Therefore, the strength of the welded metal is hardly affected by the dilution of the base metal component and is dependent on the component of the welding wire. In contrast, in the welding of thin steel sheets, the welding is often performed by one pass welding, and usually the welded metal contains 40% to 50% of the base metal component. For example, in the welding of 440 MPa class steel sheets, a low strength alloy component is dissolved in the welded metal, and in the welding of 980 MPa class steel sheets, a high strength alloy component is mixed in the welded metal.

B is an element that affects hardenability and particularly, as the carbon equivalent of the chemical composition other than B, which is the base, becomes higher, the effect of improving the strength by adding B is more easily obtained. Therefore, although the strength improvement effect by B is hardly obtained for a welded metal component including ferrite as a main structure in a low alloy such as welding of a 440 MPa class steel sheet, the strength improvement by B is remarkable for a welded metal including bainite and martensite as main structures of a high alloy of a 980 MPa class steel sheet. This is a great merit that the same wire component can be applied to welding of mild steel to high tensile steel.

That is, the effect of B by the welding wire according to the embodiment is a strength improvement effect based on the improvement of hardenability and a strength improvement effect unique to welding of thin steel sheets, which is different from the strength improvement effect due to the suppression of the formation of intergranular ferrite conventionally known in the welding of thick steel plates in terms of mechanism.

For the above reasons, the B content is 0.0030% or more, preferably 0.0032% or more, and even more preferably 0.0035% or more.

On the other hand, in a case where the B content is excessive, the elongation of the weld is lowered and thus the B content is 0.0100% or less and more preferably 0.0050% or less.

[P: More than 0 to 0.015%]

P is an element which generally comes to be mixed in a steel as one of impurities and is usually contained as an impurity in a solid wire for arc welding. Here, P is one of the major elements, which cause hot cracking in a deposited metal, and is desirably suppressed as much as possible. When the P content is more than 0.015%, hot cracking in the deposited metal become remarkable. Thus, the P content is 0.015% Of more.

Although the lower limit of the P content is not particularly limited, the P content is more than 0% or from a viewpoint of the cost of dephosphorization and productivity, the P content may be 0.001% or more.

[S: More than 0 to 0.030%]

Like P, S is also an element which generally comes to be mixed in a steel as one of impurities and is usually contained as an impurity in a solid wire for arc welding. Thus, the S content may be more than 0%.

In addition, S has an effect of increasing the surface tension at the center portion of a molten pool higher than the surface tension in the vicinity of the molten pool and allows slag to be collected at the center of the weld bead by generating inward convection in a weld pool. This utilizes a phenomenon that when S is added, the surface tension at the center portion of the molten pool with a high temperature is higher than the surface tension in the vicinity of the molten pool with a low temperature due to the temperature dependence of the surface tension. Thus, a Si- or Mn-based slag can be prevented from remaining at the toe portion of the weld bead and the electrodeposition coating properties can be improved. Therefore, the S content is preferably 0.001% or more.

On the other hand, when the S content is more than 0.030%, solidification cracking occurs in the deposited metal. Thus, the S content is 0.030% or less and preferably 0.020% or less.

Sb, Cu, Cr, Nb, V, Mo, Ni, and B are not essential components, but if required, one or two or more thereof may be contained at the same time. The effects and the upper limits obtained by including each element will be described. The lower limit in a case where these elements are not contained is 0%.

[Sb: 0 to 0.10%]

Like S, Sb generates inward convection in the weld pool by increasing the surface tension of the molten pool and allows slag to be collected at the center of the weld bead. Thus, a Si- or Mn-based slag can be prevented from remaining at the toe portion of the weld bead and the electrodeposition coating properties can be improved.

In order to obtain this effect, the Sb content is preferably set to 0.01% or more. On the other hand, when the Sb content is excessive, solidification cracking occurs in the deposited metal. Therefore, the Sb content is 0.10% or less.

[Cu: 0 to 0.50%]

In a solid wire for arc welding, copper coating is often applied to stabilize wire feedability and electrical conductivity. Thus, in a case where copper coating is applied, a certain amount of Cu is contained in the solid wire.

On the other hand, when the Cu content is excessive, weld cracking is likely to occur and thus the Cu content is 0.50% or less.

[Cr: 0 to 1.5%]

Cr may be contained to improve the hardenability of the weld and improve the tensile strength, but in a case where Cr is excessively contained, the elongation of the weld is lowered. Thus, the Cr content is 1.5% or less.

[Nb: 0 to 0.3%]

Nb may be contained to improve the hardenability of the weld and improve the tensile strength, but in a case where Nb is excessively contained, the elongation of the weld is lowered. Thus, the Nb content is 0.3% or less and more preferably 0.005% or less.

[V: 0 to 0.3%]

V may be contained to improve the hardenability of the weld and improve the tensile strength, but in a case where V is excessively contained, the elongation of the weld is lowered. Thus, the V content is 0.3% or less.

[Mo: 0 to 1.0%]

Mo may be contained to improve the hardenability of the weld and improve the tensile strength, but in a case where Mo is excessively contained, the elongation of the weld is lowered. Thus, the Mo content is 1.0% or less.

[Ni: 0 to 3.0%]

Ni may be contained to improve the tensile strength and the elongation of the weld, but in a case where Ni is excessively contained, weld cracking is likely to occur. Thus, the Ni content is 3.0% or less.

The remainder of the component described above includes Fe and impurities. The impurities are components contained in a raw material, or components mixed in a manufacturing process, which are not intentionally added in a solid wire.

As described above, S and Sb are elements that can suppress the adverse effect on the electrodeposition coating properties due to a Si- or Mn-based slag. This effect is about 4 times greater for Sb than S comparison with the same mass.

Therefore, in the present invention, it is preferable that the S and Sb contents are set so as to satisfy Expression (3). In addition, in a case where Sb is not contained, 0 is substituted for Sb.

0.012≤4×S+Sb≤0.120 Expression (3)

When the value of 4×S +Sb is 0.012 or more, the surface tension of the molten pool is increased so that inward convection can be generated in the weld pool. Thus, a Si- or Mn-based slag can be prevented from remaining at the toe portion of the weld bead and the electrodeposition coating properties can be improved. Thus, the value of 44×S +Sb is 0.012 or more and preferably 0.030 or more.

On the other hand, when the value of 4×S +Sb is 0.120 or less, it is possible to prevent the slag from being excessively concentrated at the center of the weld bead. Thus, the value of 4×S +Sb is 0.120 or less and preferably 0.100 or less.

Further, in the solid wire according to this embodiment, it is preferable that the Si, Mn, Ti, Al, S, and Sb contents are set so as to satisfy Expression (4). In addition, in a case where Sb is not contained, 0 is substituted for Sb.

(Si+Mn/5)/((Ti+Al)×(4×S+Sb))≤220 Expression (4)

When the value of (Si+Mn/5)/((Ti+Al)×(4×S+Sb)) is 220 or less, an effect of suppressing the generation of a Si- or Mn-based slag obtained by Ti and Al and an effect of collecting a Si- or Mn-based slag at the center of the weld bead obtained by S and Sb are combined and thus adverse effects on electrodeposition coating properties due to the Si- or Mn-based slag can be reliably suppressed.

The value of (Si+Mn/5)/((Ti+Al)×(4×S+Sb)) is preferably 120 or less and more preferably 100 or less.

Further, in the solid wire according to this embodiment, it is preferable that the B and Ti contents are set so as to satisfy Expression (5).

B≥(−54Ti+43)/10000 Expression (5)

In the welding of thick steel plates, it is known that, together with an effect of suppressing the formation of intergranular ferrite by the addition of B, and intergranular needle-shaped ferrite formation is promoted by the multiple addition of Ti to improve the toughness of the welded metal. This promotes the formation of ferrite with a Ti oxide or nitride as a nucleus, for example, the Ti content is about 0.01 to 0.05%.

In contrast, the Ti content in the solid wire according to this embodiment is 0.06 to 0.3%, and a relatively large amount of Ti is required. This is because Ti perform the deoxidizing action of the welded metal during welding instead of Si. However, compared with deoxidation with Si, deoxidation with Ti tends to leave oxides in the welded metal, and the amount of oxygen of the welded metal is increased.

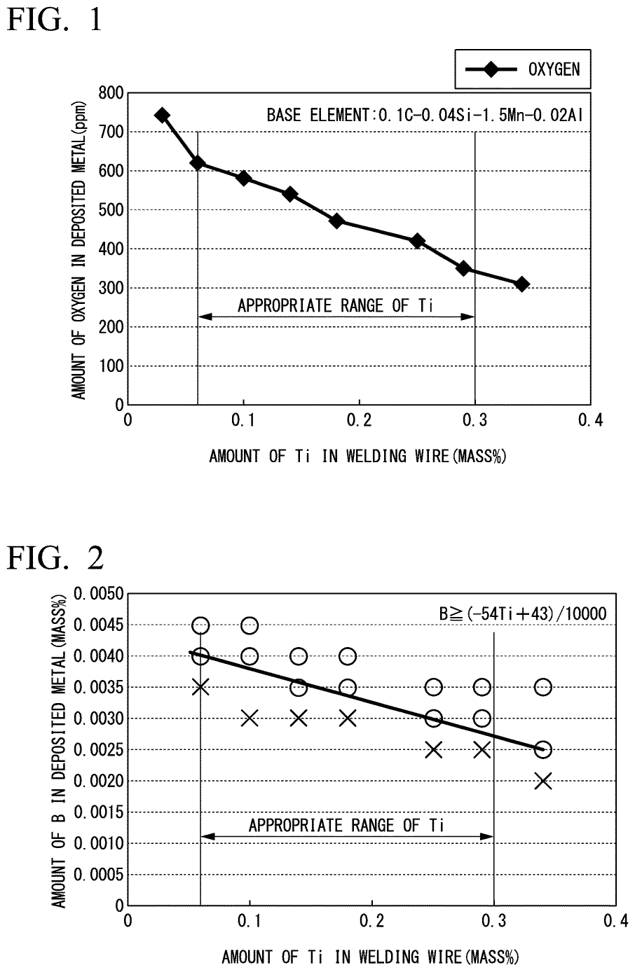

FIG. 1 shows the amount of oxygen in a deposited metal component prepared in a deposited metal test (using an Ar+20% CO₂ shielding gas). In a normal wire in which the amount of Si added is about 0.4 to 0.7, the amount of oxygen is about 200 to 300 ppm, but in the welding wire chemical composition according to the embodiment, the amount of oxygen is increased to about 300 to 600 ppm according to the Ti content. In this manner, in the wire chemical composition according to the embodiment, since a high oxygen deposited metal component is obtained, B added to the welding wire oxidized and consumed, making it difficult to remain on the deposited metal. Thus, it is desirable that the amount of B added is increased according to an increase in the amount of oxygen of the deposited metal. FIG. 2 shows results of investigating the amount of B added required for the welding wire with the purpose of setting the amount of B of the deposited metal to 0.0015% by mass or more and shows that in a case where Expression (5) is satisfied, an appropriate amount of B in the deposited metal can be secured.

### EXAMPLES

Hereinafter, the effects of the present invention will be specifically described with reference to examples.

A base steel was melted in a vacuum and was subjected to forging, rolling, wire drawing, annealing, and finish drawing to a product diameter of 1.2 mm. Then, if required, the surface of the wire was coated with copper and formed in a 20 kg winding spool, and the winding spool was used as a prototype. The chemical composition and calculated values of the prototype solid wire are shown in Tables 1 to 3. The numerical values outside the scope of the present invention were underlined. In addition, the components not contained were left blank in the table.

TABLE 1

| | C | Si | Mn | Ti | Al | B | P | S |
|---|---|---|---|---|---|---|---|---|
| Wire No. | (mass %) | | | | | | | |
| Wire 1 | 0.07 | 0.12 | 1.1 | 0.13 | 0.007 | 0.0042 | 0.010 | 0.008 |
| Wire 2 | 0.11 | 0.02 | 1.6 | 0.16 | 0.022 | 0.0042 | 0.008 | 0.005 |
| Wire 3 | 0.15 | 0.05 | 2.1 | 0.20 | 0.034 | 0.0042 | 0.014 | 0.007 |
| Wire 4 | 0.08 | 0.12 | 1.7 | 0.28 | 0.002 | 0.0031 | 0.007 | 0.024 |
| Wire 5 | 0.15 | 0.18 | 1.6 | 0.18 | 0.080 | 0.0050 | 0.005 | 0.011 |
| Wire 6 | 0.10 | 0.01 | 1.8 | 0.06 | 0.110 | 0.0048 | 0.012 | 0.008 |
| Wire 7 | 0.08 | 0.02 | 1.5 | 0.15 | 0.020 | 0.0041 | 0.009 | 0.004 |
| Wire 8 | 0.10 | 0.09 | 0.7 | 0.13 | 0.070 | 0.0034 | 0.008 | 0.001 |
| Wire 9 | 0.06 | 0.10 | 1.0 | 0.18 | 0.020 | 0.0040 | 0.130 | 0.021 |
| Wire 10 | 0.06 | 0.05 | 0.7 | 0.13 | 0.070 | 0.0042 | 0.005 | 0.007 |
| Wire 11 | 0.06 | 0.10 | 1.0 | 0.18 | 0.020 | 0.0062 | 0.005 | 0.002 |
| Wire 12 | 0.06 | 0.10 | 1.0 | 0.18 | 0.020 | 0.0047 | 0.005 | 0.002 |
| Wire 13 | 0.10 | 0.04 | 1.5 | 0.14 | 0.050 | 0.0030 | 0.005 | 0.002 |
| Wire 14 | 0.06 | 0.02 | 0.3 | 0.18 | 0.030 | 0.0035 | 0.007 | 0.003 |
| Wire 15 | 0.06 | 0.02 | 0.6 | 0.13 | 0.020 | 0.0042 | 0.007 | 0.003 |
| Wire 16 | 0.11 | 0.04 | 1.7 | 0.16 | 0.002 | 0.0034 | 0.008 | 0.005 |
| Wire 17 | 0.12 | 0.05 | 1.7 | 0.22 | 0.280 | 0.0031 | 0.007 | 0.007 |
| Wire 18 | 0.11 | 0.06 | 2.1 | 0.29 | 0.030 | 0.0027 | 0.007 | 0.011 |
| Wire 19 | 0.12 | 0.05 | 1.9 | 0.07 | 0.080 | 0.0092 | 0.008 | 0.005 |
| Wire 20 | 0.10 | 0.04 | 1.6 | 0.16 | 0.020 | 0.0042 | 0.006 | 0.008 |
| Wire 21 | 0.08 | 0.04 | 1.7 | 0.07 | 0.110 | 0.0043 | 0.011 | 0.008 |
| Wire 22 | 0.10 | 0.02 | 1.5 | 0.10 | 0.080 | 0.0041 | 0.008 | 0.007 |
| Wire 23 | 0.10 | 0.04 | 1.6 | 0.15 | 0.030 | 0.0042 | 0.007 | 0.005 |
| Wire 24 | 0.04 | 0.04 | 1.3 | 0.07 | 0.010 | 0.0041 | 0.008 | 0.011 |
| Wire 25 | 0.18 | 0.02 | 1.7 | 0.15 | 0.020 | 0.0036 | 0.010 | 0.008 |
| Wire 26 | 0.11 | 0.21 | 1.8 | 0.18 | 0.020 | 0.0043 | 0.007 | 0.008 |
| Wire 27 | 0.08 | 0.05 | 0.2 | 0.07 | 0.020 | 0.0041 | 0.005 | 0.008 |
| Wire 28 | 0.11 | 0.02 | 2.5 | 0.15 | 0.040 | 0.0032 | 0.008 | 0.008 |
| Wire 29 | 0.08 | 0.04 | 1.5 | 0.05 | 0.100 | 0.0051 | 0.008 | 0.007 |
| Wire 30 | 0.08 | 0.06 | 1.6 | 0.32 | 0.002 | 0.0034 | 0.006 | 0.005 |
| Wire 31 | 0.11 | 0.04 | 1.7 | 0.15 | 0.320 | 0.0038 | 0.008 | 0.005 |
| Wire 32 | 0.07 | 0.02 | 1.5 | 0.14 | 0.030 | 0.0024 | 0.007 | 0.007 |
| Wire 33 | 0.11 | 0.17 | 1.8 | 0.19 | 0.020 | 0.0067 | 0.012 | 0.005 |
| Wire 34 | 0.10 | 0.08 | 1.7 | 0.09 | 0.040 | 0.0045 | 0.007 | 0.004 |
| Wire 35 | 0.08 | 0.03 | 1.6 | 0.10 | 0.030 | 0.0032 | 0.008 | 0.025 |
| Wire 36 | 0.10 | 0.07 | 1.6 | 0.12 | 0.020 | 0.0042 | 0.010 | 0.003 |

TABLE 2

| | Sb | Cu | Cr | Nb | V | Mo | Ni | |
|---|---|---|---|---|---|---|---|---|
| Wire No. | (mass %) | | | | | | | Remainder |
| Wire 1 | | 0.34 | | | | | | Fe and impurities |
| Wire 2 | | 0.34 | | | | | | Fe and impurities |
| Wire 3 | | 0.35 | | | | | | Fe and impurities |
| Wire 4 | | 0.34 | | | | | | Fe and impurities |
| Wire 5 | | 0.31 | | | | | | Fe and impurities |
| Wire 6 | | 0.32 | | | | | | Fe and impurities |
| Wire 7 | | 0.33 | | | | | | Fe and impurities |
| Wire 8 | 0.03 | 0.35 | | | | | | Fe and impurities |
| Wire 9 | 0.007 | 0.47 | | | | | | Fe and impurities |
| Wire 10 | | 0.31 | 0.9 | | | | | Fe and impurities |
| Wire 11 | 0.01 | 0.29 | | 0.04 | | | | Fe and impurities |
| Wire 12 | 0.07 | 0.32 | | | 0.2 | | | Fe and impurities |
| Wire 13 | 0.07 | 0.34 | | | | 0.2 | | Fe and impurities |
| Wire 14 | | 0.32 | | | | | 2.3 | Fe and impurities |
| Wire 15 | 0.001 | 0.32 | 0.3 | 0.02 | 0.08 | 0.3 | 2.4 | Fe and impurities |
| Wire 16 | | | | | | | | Fe and impurities |
| Wire 17 | 0.01 | | | | | | | Fe and impurities |
| Wire 18 | 0.02 | 0.33 | | | | | | Fe and impurities |
| Wire 19 | | 0.32 | | | | | | Fe and impurities |
| Wire 20 | | 0.34 | | 0.21 | | | | Fe and impurities |
| Wire 21 | | 0.31 | | | | | | Fe and impurities |
| Wire 22 | | 0.31 | | | | | | Fe and impurities |
| Wire 23 | | 0.32 | | | | | | Fe and impurities |
| Wire 24 | | 0.31 | | | | | | Fe and impurities |
| Wire 25 | | 0.35 | | | | | | Fe and impurities |
| Wire 26 | | 0.32 | | | | | | Fe and impurities |
| Wire 27 | | 0.33 | | | | | | Fe and impurities |
| Wire 28 | | 0.32 | | | | | | Fe and impurities |
| Wire 29 | | 0.31 | | | | | | Fe and impurities |
| Wire 30 | | 0.33 | | | | | | Fe and impurities |
| Wire 31 | | 0.31 | | | | | | Fe and impurities |
| Wire 32 | | 0.33 | | | | | | Fe and impurities |
| Wire 33 | | 0.31 | | | | | | Fe and impurities |
| Wire 34 | | 0.32 | | | | | | Fe and impurities |
| Wire 35 | 0.03 | 0.34 | | | | | | Fe and impurities |
| Wire 36 | | 0.34 | | | | | | Fe and impurities |

TABLE 3

| | | | | (Si + Mn/5)/ | (−54Ti + |
|---|---|---|---|---|---|
| Wire | | (Si + Mn/5)/ | 4 × S + | ((Ti + Al) × | 43)/ |
| No. | Si × Mn | (Ti + Al) | Sb | (4 × S + Sb)) | 10000 |
| Wire 1 | 0.13 | 2.5 | 0.032 | 78 | 0.0036 |
| Wire 2 | 0.03 | 1.9 | 0.020 | 93 | 0.0034 |
| Wire 3 | 0.11 | 2.0 | 0.028 | 72 | 0.0032 |
| Wire 4 | 0.20 | 1.6 | 0.096 | 17 | 0.0028 |
| Wire 5 | 0.29 | 1.9 | 0.044 | 44 | 0.0033 |
| Wire 6 | 0.02 | 2.2 | 0.032 | 68 | 0.0040 |
| Wire 7 | 0.03 | 1.9 | 0.016 | 118 | 0.0035 |
| Wire 8 | 0.06 | 1.2 | 0.034 | 34 | 0.0036 |
| Wire 9 | 0.10 | 1.5 | 0.091 | 16 | 0.0033 |
| Wire 10 | 0.04 | 1.0 | 0.028 | 34 | 0.0036 |
| Wire 11 | 0.10 | 1.5 | 0.018 | 83 | 0.0033 |
| Wire 12 | 0.10 | 1.5 | 0.078 | 19 | 0.0033 |
| Wire 13 | 0.06 | 1.8 | 0.078 | 23 | 0.0035 |
| Wire 14 | 0.01 | 0.4 | 0.012 | 32 | 0.0033 |
| Wire 15 | 0.01 | 0.9 | 0.013 | 72 | 0.0036 |
| Wire 16 | 0.07 | 2.3 | 0.020 | 117 | 0.0034 |
| Wire 17 | 0.09 | 0.8 | 0.038 | 21 | 0.0031 |
| Wire 18 | 0.13 | 1.5 | 0.064 | 23 | 0.0027 |
| Wire 19 | 0.10 | 2.9 | 0.020 | 143 | 0.0039 |
| Wire 20 | 0.06 | 2.0 | 0.032 | 63 | 0.0034 |
| Wire 21 | 0.07 | 2.1 | 0.032 | 66 | 0.0039 |
| Wire 22 | 0.03 | 1.8 | 0.028 | 63 | 0.0038 |
| Wire 23 | 0.06 | 2.0 | 0.020 | 100 | 0.0035 |
| Wire 24 | 0.05 | 3.8 | 0.044 | 85 | 0.0039 |
| Wire 25 | 0.03 | 2.1 | 0.032 | 66 | 0.0035 |
| Wire 26 | 0.38 | 2.9 | 0.032 | 89 | 0.0033 |
| Wire 27 | 0.01 | 1.0 | 0.032 | 31 | 0.0039 |
| Wire 28 | 0.05 | 2.7 | 0.032 | 86 | 0.0035 |
| Wire 29 | 0.06 | 2.3 | 0.028 | 81 | 0.0040 |
| Wire 30 | 0.10 | 1.2 | 0.020 | 59 | 0.0026 |
| Wire 31 | 0.07 | 0.8 | 0.020 | 40 | 0.0035 |
| Wire 32 | 0.03 | 1.9 | 0.028 | 67 | 0.0035 |
| Wire 33 | 0.31 | 2.5 | 0.020 | 126 | 0.0033 |
| Wire 34 | 0.14 | 3.2 | 0.016 | 202 | 0.0038 |
| Wire 35 | 0.05 | 2.7 | 0.130 | 21 | 0.0038 |
| Wire 36 | 0.11 | 2.8 | 0.012 | 232 | 0.0037 |

Using the prototype solid wire, lap fillet welding was performed on steel sheets a and steel sheets b shown in Table 4 to measure the area of poor electrodeposition coating. The tensile strength of the welded metal was determined by a deposited metal performance test in accordance with JIS Z 3111.

TABLE 4

| | Sheet | Tensile | Chemical composition | | | | | | | | |
|---|---|---|---|---|---|---|---|---|---|---|---|
| | thickness | strength | C | Si | Mn | Ti | Al | B | P | S | Remainder |
| | mm | MPa | Mass % | | | | | | | | |
| Steel | 2.0 | 440 | 0.15 | 0.02 | 0.6 | 0.004 | 0.02 | 0.0002 | 0.014 | 0.007 | Fe and |
| sheet a | | | | | | | | | | | impurities |
| Steel | 2.3 | 980 | 0.11 | 0.27 | 2.3 | 0.02 | 0.03 | 0.0015 | 0.009 | 0.006 | Fe and |
| sheet b | | | | | | | | | | | impurities |

(Tensile Test of Deposited Metal)

The tensile test of the deposited metal was performed according to JIS Z 3111. According to JISZ 3112 YGW12, which is the standard for a welding wire, in a case where the lower limit of the tensile strength (TS) was 490 MPa or more, it was determined that the tensile strength was good, and in a case where the fracture surface was a ductile fracture surface, it was determined that the elongation was good.

(Measurement of Area Ratio of Poor Electrodeposition Coating)

After a weld test piece was degreased and subjected to chemical conversion, electrodeposition coating was applied to the test piece to have a film thickness of 20 μm. Then, the electrodeposition coating portion of the weld bead was photographed and a ratio of the area of poor electrodeposition coating to the weld bead area from the image was measured. In addition, the bead length of the weld test piece was 120 mm, and the defective rate of electrodeposition coating was calculated from a weld bead having a length of 90 mm excluding 15 mm at the welding start portion and the end portion. The electrodeposition coating was identified using a gray coating to identify a poor electrodeposition coating portion where reddish brown and black slags were exposed. In a case where the poor coating area ratio was 5% or less in terms of area ratio, it was determined that the electrodeposition coating rate was good.

The results are shown in Table 5.

TABLE 5

| | | | | Steel sheet a | | Steel sheet b | | |
|---|---|---|---|---|---|---|---|---|
| | | | | | Area | | Area | |
| | | Tensile test of | | Fractured | ratio | Fractured | ratio | |
| | | deposited metal | | location of | of poor | location of | of poor | |
| Experiment | Wire | TS | Fracture | welded joint | coating | welded joint | coating | |
| No. | No. | (MPa) | surface | test | (%) | test | (%) | Sort |
| 1 | Wire 1 | 556 | | Base steel | 3.6 | Base steel | 4.2 | Invention Example |
| 2 | Wire 2 | 582 | | Base steel | 0.0 | Base steel | 0.5 | Invention Example |
| 3 | Wire 3 | 782 | | Base steel | 3.0 | Base steel | 3.6 | Invention Example |
| 4 | Wire 4 | 713 | | Base steel | 2.7 | Base steel | 2.7 | Invention Example |
| 5 | Wire 5 | 767 | | Base steel | 4.5 | Base steel | 4.7 | Invention Example |
| 6 | Wire 6 | 612 | | Base steel | 0.0 | Base steel | 0.0 | Invention Example |
| 7 | Wire 7 | 624 | | Base steel | 0.0 | Base steel | 0.9 | Invention Example |
| 8 | Wire 8 | 541 | | Base steel | 0.0 | Base steel | 1.2 | Invention Example |
| 9 | Wire 9 | 581 | | Base steel | 1.2 | Base steel | 2.7 | Invention Example |
| 10 | Wire 10 | 663 | | Base steel | 0.0 | Base steel | 0.5 | Invention Example |
| 11 | Wire 11 | 673 | | Base steel | 1.8 | Base steel | 1.9 | Invention Example |
| 12 | Wire 12 | 731 | | Base steel | 2.2 | Base steel | 3.4 | Invention Example |
| 13 | Wire 13 | 723 | | Base steel | 0.0 | Base steel | 1.8 | Invention Example |
| 14 | Wire 14 | 542 | | Base steel | 0.0 | Base steel | 0.0 | Invention Example |
| 15 | Wire 15 | 729 | | Base steel | 0.0 | Base steel | 0.7 | Invention Example |
| 16 | Wire 16 | 652 | | Base steel | 1.1 | Base steel | 0.0 | Invention Example |
| 17 | Wire 17 | 821 | | Base steel | 1.5 | Base steel | 2.3 | Invention Example |
| 18 | Wire 18 | 712 | | Base steel | 3.8 | Base steel | 4.1 | Invention Example |
| 19 | Wire 19 | 663 | | Base steel | 2.7 | Base steel | 3.3 | Invention Example |
| 20 | Wire 20 | 641 | | Base steel | 0.0 | Base steel | 1.4 | Invention Example |
| 21 | Wire 21 | 622 | | Base steel | 0.0 | Base steel | 0.7 | Invention Example |
| 22 | Wire 22 | 587 | | Base steel | 0.0 | Base steel | 0.9 | Invention Example |
| 23 | Wire 23 | 611 | | Base steel | 0.0 | Base steel | 1.4 | Invention Example |
| 24 | Wire 24 | 401 | | Welded | 0.0 | Welded | 0.7 | Comparative |
| | | | | metal | | metal | | Example |
| 25 | Wire 25 | 830 | Brittle | Base steel | 0.0 | Base steel | 1.3 | Comparative |
| | | | | | | | | Example |
| 26 | Wire 26 | 651 | | Base steel | 6.8 | Base steel | 7.1 | Comparative |
| | | | | | | | | Example |
| 27 | Wire 27 | 413 | | Welded | 1.5 | Welded | 1.8 | Comparative |
| | | | | metal | | metal | | Example |
| 28 | Wire 28 | 813 | Brittle | Base steel | 4.9 | Base steel | 1.7 | Comparative |
| | | | | | | | | Example |
| 29 | Wire 29 | 531 | | Base steel | 8.9 | Base steel | 4.5 | Comparative |
| | | | | | | | | Example |
| 30 | Wire 30 | 721 | Brittle | Base steel | 0.0 | Base steel | 1.5 | Comparative |
| | | | | | | | | Example |
| 31 | Wire 31 | 780 | Brittle | Base steel | 0.0 | Base steel | 0.8 | Comparative |
| | | | | | | | | Example |
| 32 | Wire 32 | 581 | | Base steel | 0.0 | Welded | 0.8 | Comparative |
| | | | | | | metal | | Example |
| 33 | Wire 33 | 689 | | Base steel | 6.5 | Base steel | 7.2 | Comparative |
| | | | | | | | | Example |
| 34 | Wire 34 | 613 | | Base steel | 7.1 | Base steel | 9.5 | Comparative |
| | | | | | | | | Example |
| 35 | Wire 35 | 552 | | Base steel | 3.7 | Base steel | 4.8 | Invention Example |
| 36 | Wire 36 | 617 | | Base steel | 3.4 | Base steel | 4.7 | Invention Example |

In Experiment Nos. 1 to 23, 35, and 36 according to Invention Examples, the weld having excellent electrodeposition coating properties and mechanical properties could be formed due to the proper composition of the components.

In Experiment No. 24 related to Comparative Example, since the C content was below the appropriate range, the tensile strength in the deposited metal was not sufficient.

In Experiment No. 25 related to Comparative Example, since the C content exceeded the appropriate range, the deposited metal was hardened and thus brittle fracture occurred in the tensile test. That is, excellent cracking resistance could not be obtained.

In Experiment No. 26 related to Comparative Example, since the Si content exceeded the appropriate range, an insulating Si-based slag was generated on the surface of the weld bead, and poor electrodeposition coating occurred.

In Experiment No. 27 related to Comparative Example, since the Mn content was below the appropriate range, the tensile strength in the deposited metal was not sufficient.

In Experiment No. 28 related to Comparative Example, since the Mn content exceeded the appropriate range, an insulating Mn-based slag was generated on the surface of the weld bead, and poor electrodeposition coating occurred.

In Experiment No. 29 related to Comparative Example, since the Ti content was below the appropriate range, the effect of imparting conductivity to the slag was not sufficient and poor electrodeposition coating could not be prevented from occurring.

In Experiment No. 30 related to Comparative Example, since the Ti content exceeded the appropriate range, the Ti-based oxides reduced ductility, and the elongation of the weld was not sufficient.

In Experiment No. 31 related to Comparative Example, since the Al content exceeded the appropriate range, the Al-based oxides reduced ductility, and the elongation of the weld was not sufficient.

In Experiment No. 32 related to Comparative Example, since the B content was below the appropriate range, the strength in the welded metal could not be sufficiently secured in the welding of high strength steel sheets.

In Experiment No. 33 related to Comparative Example, since the value of Si x Mn exceeded the appropriate range, a large amount of Si- and Mn-based slags were generated in the weld bead. Thus, poor electrodeposition coating could not be prevented from occurring.

In Experiment No. 34 related to Comparative Example, since the value of (Si+Mn/5)/(Ti+Al) exceeded the appropriate range, the effect of suppressing the generation of a Si- or Mn-based slag by Ti and Al and the effect of imparting conductivity to the slag by Ti were not sufficient. Therefore, poor electrodeposition coating could not be prevented from occurring.

### INDUSTRIAL APPLICABILITY

According to the present invention, it is possible to provide a solid wire for gas-shielded arc welding capable of forming a weld having excellent electrodeposition coating properties and mechanical properties and applicable to both welding of low strength steel sheets and welding of high strength steel sheets, and the utilizability in industry is high.

1. A solid wire for gas-shielded arc welding for joining a plurality of thin steel sheets by gas-shielded arc welding, the wire comprising, in mass %, with respect to a total mass of the wire:
C: 0.06 to 0.15%;
Si: more than 0 to 0.18%;
Mn: 0.3 to 2.2%;
Ti: 0.06 to 0.30%;
Al: 0.001 to 0.30%;
B: 0.0030 to 0.0100%;
P: more than 0 to 0.015%;
S: more than 0 to 0.030%;
Sb: 0 to 0.10%;
Cu: 0 to 0.50%;
Cr: 0 to 1.5%;
Nb: 0 to 0.3%;
V: 0 to 0.3%;
Mo: 0 to 1.0%;
Ni: 0 to 3.0%; and
a remainder consisting of iron and impurities,
wherein Si, Mn, Ti, and Al satisfy Expressions (1) and (2),
Si×Mn≤0.30 Expression (1)
(Si+Mn/5)/(Ti+Al)≤3.0 Expression (2)
where element symbols in Expressions (1) and (2) represent contents (mass %) of individual elements.

2. The solid wire for gas-shielded arc welding according to claim 1, wherein an Al content is 0.01 to 0.14%.

3. The solid wire for gas-shielded arc welding according to claim 1,
wherein Si, Mn, Ti, Al, S, and Sb satisfy Expressions (3) and (4),
0.012≤4×S+Sb≤0.120 Expression (3)
(Si+Mn/5)/((Ti+Al)×(4×S+Sb))≤220 Expression (4)
where element symbols in Expressions (3) and (4) represent contents (mass %) of individual elements.

4. The solid wire for gas-shielded arc welding according to claim 1,
wherein a Nb content is 0.005% or less.

5. The solid wire for gas-shielded arc welding according to claim 1,
wherein a B content is 0.0032% or more.

6. The solid wire for gas-shielded arc welding according to claim 1,
wherein a Mn content is 0.3 to 1.7%.

7. The solid wire for gas-shielded arc welding according to claim 1,
wherein B and Ti satisfy Expression (5),
B≥(−54Ti+43)/10000 Expression (5)
where element symbols in Expression (5) represent contents (mass %) of individual elements.

8. The solid wire for gas-shielded arc welding according to claim 2,
wherein Si, Mn, Ti, Al, S, and Sb satisfy Expressions (3) and (4),
0.012≤4×S+Sb≤0.120 Expression (3)
(Si+Mn/5)/((Ti+Al)×(4×S+Sb))≤220 Expression (4)
where element symbols in Expressions (3) and (4) represent contents (mass %) of individual elements.

9. The solid wire for gas-shielded arc welding according to claim 2,
wherein a Nb content is 0.005% or less.

10. The solid wire for gas-shielded arc welding according to claim 2,
wherein a B content is 0.0032% or more.

11. The solid wire for gas-shielded arc welding according to claim 2,
wherein a Mn content is 0.3 to 1.7%.

12. The solid wire for gas-shielded arc welding according to claim 2,
wherein B and Ti satisfy Expression (5),
B≥(−54Ti+43)/10000 Expression (5)
where element symbols in Expression (5) represent contents (mass %) of individual elements.

13. A solid wire for gas-shielded arc welding for joining a plurality of thin steel sheets by gas-shielded arc welding, the wire comprising, in mass %, with respect to a total mass of the wire:
C: 0.06 to 0.15%;
Si: more than 0 to 0.18%;
Mn: 0.3 to 2.2%;
Ti: 0.06 to 0.30%;
Al: 0.001 to 0.30%;
B: 0.0030 to 0.0100%;
P: more than 0 to 0.015%;
S: more than 0 to 0.030%;
Sb: 0 to 0.10%;
Cu: 0 to 0.50%;
Cr: 0 to 1.5%;
Nb: 0 to 0.3%;
V: 0 to 0.3%;
Mo: 0 to 1.0%;
Ni: 0 to 3.0%; and
a remainder comprises iron and impurities,
wherein Si, Mn, Ti, and Al satisfy Expressions (1) and (2),
Si×Mn≤0.30 Expression (1)
(Si+Mn/5)/(Ti+Al)≤3.0 Expression (2)
where element symbols in Expressions (1) and (2) represent contents (mass %) of individual elements.
